(19) United States
(12) Patent Application Publication
(10) Pub. No.: US 2004/0025004 A1
(43) Pub. Date: Feb. 5, 2004

(54) Reconfigurable logic signal processor (RLSP) and method of configuring same

(76) Inventors: Robert Mark Gorday, Wellington, FL (US); David Taubenheim, Deerfield Beach, FL (US); Clinton Powell, Austin, TX (US)

Correspondence Address: Larson & Associates, P.C., 221 East Church Street, Frederick, MD, 21701-5405, US

(21) Appl. No.: 10/211,738

(22) Filed: Aug. 2, 2002

(51) Int. Cl. G06F 15/177

(52) U.S. Cl. 713/100

(57) ABSTRACT

A reconfigurable logic signal processor (RLSP) (100) and method of configuring same in accordance with the present invention stores a plurality of configuration files (262, 264, . . . , 266) in a configuration storage memory (212) in compressed form. A portion of the reconfigurable resources (204) of the RLSP (100) are configured as a decompresser to provide for decompression of the compressed configuration files (262, 264, . . . , 266). The reconfigurable resources (204) of the RLSP (100) may be utilized to implement signal processing functions (114) as well as process control processor instructions and/or configuration data (120), such as for example decompression of compressed configuration data. When decompression functions are complete, a non-decompression instruction can be executed using the reconfigurable resources allocated to decompression by reallocation of those resources.

### FIELD OF THE INVENTION

This invention relates generally to the field of Reconfigurable Logic Signal Processors (RLSP). More particularly, this invention relates to reconfiguration of an RLSP to carry out actions on configuration instructions and/or control processor instructions such as decompression of compressed configuration data in an RLSP system.

### BACKGROUND OF THE INVENTION

Next generation wireless communication products are being designed with modem architectures capable of supporting many wireless protocols (communication modes). In order to minimize the cost, power, and size of these multi-mode modems, some of these architectures will be designed for increased software configurability with a minimized set of hardware resources necessary for implementing a set of wireless protocols. The general term Software Definable Radio (SDR) is often used for these new modem architectures used in a wireless environment.

Some of these new SDR architectures may have traditional Digital Signal Processors (DSPs) and newer Reconfigurable Logic Signal Processors (RLSPs). Both types of signal processing structures use hardware that is configured/controlled via software. However, the RLSP architectures have many parallel processing structures that are individually reconfigurable, in some cases by another processor. Each structure of a reconfigurable resource is configured when configuration data bits are loaded into the configuration registers of that structure. The combined set of configuration bits of all resources is analogous to a very long instruction word that may have hundreds, thousands or even tens of thousands or more bits in the word. These reconfigurable parallel processing resources are capable of performing a complex signal processing task in as little as one clock cycle. As such, they are well suited for data-path signal processing tasks such as CDMA (Code Division Multiple Access) chip rate processing. The structures are configured by loading a bit pattern, representing configuration data into the reconfigurable resources of the RLSP.

In certain embodiments, functions implemented in RLSP architectures may be implemented with an active (or primary) configuration and a series of next-up configurations. The active configuration is characterized by a configuration data bit pattern that describes how the architecture behaves presently, while a next-up configuration remains inactive until the instruction is given to make it the active configuration. These bit patterns can be stored within configuration registers within the reconfigurable resources (or equivalently, they may be stored in memories or latches). The switch between configurations can then be made to take place in as little time as a single clock cycle, by simple switching from an active set of registers to a set of registers defining the next up configuration. This way, multiple following configurations can be preloaded into registers while the actions of a current configuration are being carried out.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a high-level block diagram illustrating the operation of a reconfigurable logic signal processor consistent with certain embodiments of the present invention.

FIG. 2 is a block diagram of a RLSP consistent with certain embodiments of the present invention.

FIG. 3 is a flow chart depicting a first pipelined configuration method consistent with certain embodiments of the present invention.

FIG. 4 is a flow chart depicting a second pipelined configuration method consistent with certain embodiments of the present invention.

FIG. 5 is a flow chart depicting a non-pipelined configuration method consistent with certain embodiments of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding elements in the several views of the drawings.

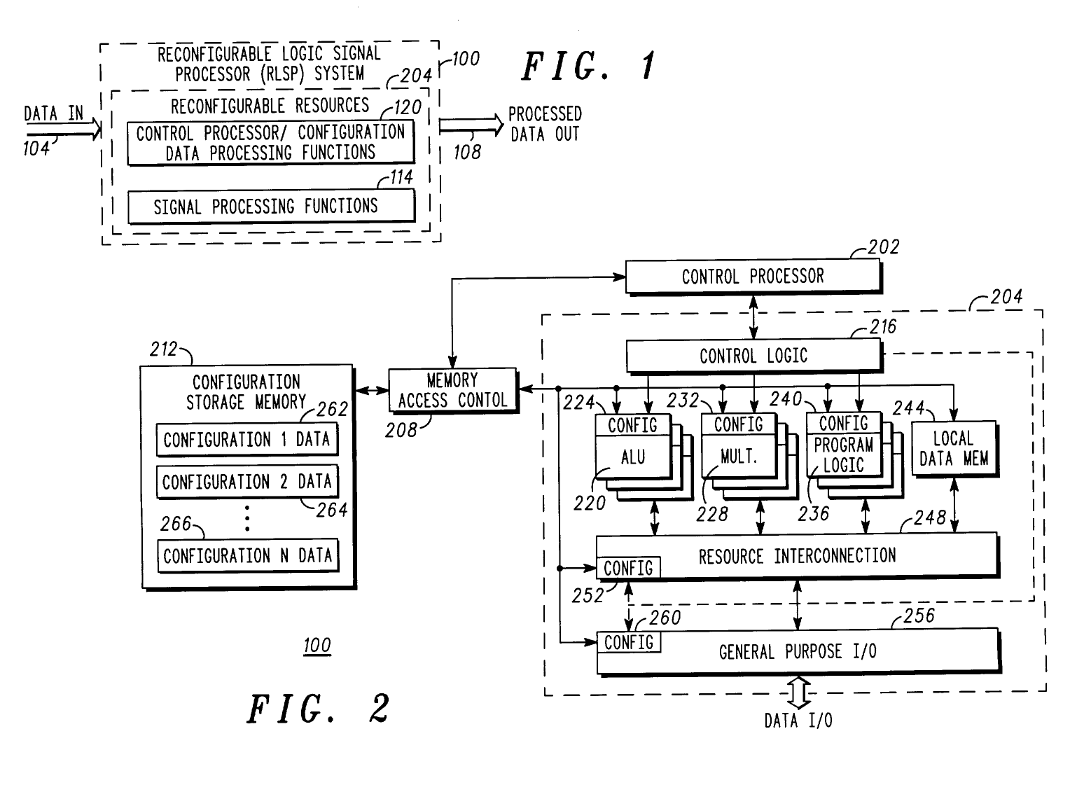

Turning now to FIG. 1, a reconfigurable logic signal processor system 100 is illustrated. RLSPs are reconfigurable by loading configuration data into registers forming a part of a block of reconfigurable resources in order to define functionality for the RLSP. In operation, signal processing functionality is loaded into the RLSP 100 in order to process an input data stream 104 to produce an output data stream 108. When the configuration data are loaded, the reconfigurable resources assume an identity (a circuit configuration) that performs all or a portion of the signal processing functions 114 required to produce the processed output data stream 108. Frequently, the RLSP is configured into multiple configurations to carry out any given set of signal processing functions. Interestingly, and in accord with certain embodiments consistent with the present invention, the RLSP 100 can carry out any number of other functions that would ordinarily require dedicated hardware resources without need for such dedicated resources.

While the RLSP is well suited to process the physical layer of a communications link, the amount of memory occupied to store the configurations becomes significant for applications with multiple air interfaces (AI) to process. This is the case with a SDR. In addition, as noted previously, the configuration data is analogous to a very long instruction word. This configuration data may be susceptible to corruption by, for example, electrostatic discharge. The configuration data may also be the target of malicious activities and thus corrupted by a hacker. This could result in loss of security, communication failure or transmission outside legal boundaries of power, frequency, bandwidth, etc.

In one example embodiment consistent with certain embodiments of the present invention, the reconfigurable resources 204 of the RLSP system 100 can be configured to carry out operations on the configuration data itself, or may carry out operations on the instructions of the control processor of the system (not shown in this diagram) as illustrated by functions 120 of FIG. 1. Such functions can include, but are not limited to: checking the integrity of the configuration data, checking the integrity of the control processor's instructions, and providing decompression of compressed configuration data as will be described later. RLSP system 100 for purposes of the present document, includes not only the reconfigurable resources 204, but can also include memory, control processor and other devices associated directly with the action of the RLSP system 100, without regard for whether or not such devices are physically integrated within a single integrated circuit or other package.

As previously mentioned, it may be desirable to store the configuration data as compressed data and to decompress the configuration data before loading into the reconfigurable resources 204 of the RLSP system 100. It is also possible to test the integrity of configuration bit pattern (whether compressed or not) and deal with other operational anomalies by configuring the reconfigurable resources 204 to carry out functions on the control processor functions or configuration data such as error checking by methods such as those disclosed in the copending application to Gorday, Taubenheim and Powell entitled “Error Checking in a Reconfigurable Logic Signal Processor (RLSP)”, attorney docket number PT03604U. By way of example, and not limitation, a portion of the reconfigurable resources can be configured to read the configuration data back from the configuration registers of the reconfigurable resources of the RLSP and checked using a checksum, CRC, etc. to determine if the configuration is correctly loaded. Other embodiments that carry out other functions on the control processor functions or configuration data will occur to those skilled in the art.

Accordingly, in certain embodiments consistent with the present invention, a reconfigurable logic signal processor (RLSP) system has a control processor executing a set of control instructions. A reconfigurable resource block is configured to perform a programmed function when configuration data are loaded into a plurality of registers. The configuration data are loaded into the plurality of registers under control of the control processor. A first plurality of registers store configuration data to configure at least a first portion of the reconfigurable resource to carry out an operation that processes at least a portion of either the configuration data or the control instructions (or both).

A method of configuring a reconfigurable logic signal processor (RLSP) system, consistent with certain embodiments of the present invention operates by, in a control processor, executing a sequence of control instructions that control the configuration of reconfigurable resources of the RLSP; executing control instructions that load a first portion and a second portion of a configuration into the reconfigurable resource block of the RLSP; wherein the first portion implements an operation that processes at least a portion of one of the configuration data and the control instructions in at least a first specified portion of the reconfigurable resource block and wherein the second portion implements a signal processing function in at least a second specified portion of the reconfigurable resource block; carrying out the operation that processes at least a portion of the configuration data and/or the control instructions using the first specified portion of the reconfigurable resource block; and carrying out the signal processing function using the second specified portion of the reconfigurable resource block.

By way of example, and not limitation, certain embodiments of the present invention can be utilized to carry out processing functions on the configuration data to mitigate memory size limitations for stored configurations that might be present in the RLSP system's memory. This can be accomplished without significantly impacting the signal processing performance of the RLSP system 100. In other embodiments, the reconfigurable resources 204 of the RLSP system 100 can be configured to carry out other functions such as checking and correcting control processor function, as well as other functions which would normally require additional dedicated hardware.

For certain currently available RLSP devices, a signal processing configuration used for a wireless two way communication air interface protocol process can occupy substantial amounts of memory. Therefore, for a software defined radio design capable of many modem configurations, each with several configurations, memory size can be a major limitation.

FIG. 2 illustrates an RLSP such as might be used for such a software-defined radio implementation wherein the reconfigurable logic signal processor (RLSP) system 100 is presented. As part of the RLSP system 100 a control processor 202 connects to a reconfigurable resources block 204 at a control logic unit 216. The control processor 202 also connects to a memory access controller (MAC) 208. The MAC 208 connects to a configuration storage memory 212. The MAC 208 connects to the reconfigurable resources block 204 at a bank of configurable arithmetic logic units (ALU) 220 at a configuration interface 224, a bank of configurable multiply units 228 at a configuration interface 232, a bank of programmable logic units 236 at a configuration interface 240, a resource interconnect unit 248 at a configuration interface 252, a general purpose input output unit 256 at a configuration interface 260, and to a local data memory 244. The configuration described above is intended to be an illustrative example of such an RLSP. Commercial RLSP systems can have different, more or fewer components that those explicitly described above without departing from the present invention.

Within the reconfigurable resources block 204 the control logic unit 216 connects to the ALU 220 at the configuration interface 224, the multiply unit 228 at the configuration interface 232, the programmable logic unit 236 at the configuration interface 240, the resource interconnect unit 248, and the general purpose input output unit 256. The resource interconnect unit 248 connects to the local data memory 244, the programmable logic unit 236, the multiply unit 228, the ALU 220, and the general purpose input output unit 256. Each of the reconfigurable resources within the reconfigurable resource block 204 has, in this embodiment, a plurality of configuration registers associated therewith. The configuration registers can store not only data defining a current configuration, but also data defining one or more “next-up” configurations that can be rapidly deployed on command from the control processor 202 via control logic 216 or by other means as will be described later.

As mentioned, in certain embodiments of such a reconfigurable resource block 204, the reconfigurable resources are configured by configuration bits stored in a plurality of registers. In addition to a current configuration, one or more sets of next-up configuration registers may be present in some embodiments so that future configurations can be loaded and stored at the same time that a current configuration is carrying out its configuration defined activity. Also, it should be noted, that the elements of the RLSP system 100 illustrated above may be present in a single integrated circuit chip, or may be separated by function in any suitable way desired by the manufacturer or designer without departing from the present invention.

For a radio architecture using an RLSP 100 and a control processor 202, such as shown in FIG. 2, it can be seen that a configuration file containing configuration data in the form of configuration bit patterns are stored in identifiable locations, such as the configuration storage memory 212 for the reconfigurable architecture. (Note that this memory can be the same memory that stores data or instructions for the control processor 202 or may be dedicated to configuration data.) The configuration file is loaded from the configuration storage memory 212 into the reconfigurable resources 204 of the RLSP architecture 100 as ordered by the control processor 102 or by a process executing on the RSLP system 100's reconfigurable resources 204 themself. Any number of such configuration files such as 262, 264, through 266 can be stored in the configuration storage memory 212 for loading into the reconfigurable resources 204 as desired. For purposes of this document, it is assumed that the RLSP system 100 is performing digital signal processing and protocol processing for a communications air interface standard, for example UMTS (universal mobile telecommunications system) WCMDA (wireless code division multiple access) and/or GSM (global system for mobile communication), but this should not be considered limiting.

It is noted that the radio may be in an environment in which more than one air interface standard may be present, and thus, it may be desirable to provide the radio with the ability to implement multiple air interface standards. As previously noted, a metropolitan location may have both WCDMA carriers and GSM carriers. Of course, there are several combinations of standards which may be present in a location. To name a few of the many current standards, there may be need to implement iDEN (integrated digital enhanced network), GPRS (general packet radio service), IS-95 CDMA (IS-95 version of code division multiple access), CDMA2000 (another version of CDMA), AMPS (advanced mobile phone service), TETRA (terrestrial trunked radio), and even with messaging standards such as ReFLEX (Motorola, Inc.'s two way messaging protocol).

The configuration files which contain bit patterns which implement the processing of an air interface in the RLSP 100 are stored in the configuration storage memory 212 as previously described. This memory can contain the bit patterns to enable processing of a number of air interfaces and may equivalently be internal or external to a commercial RLSP chip itself. The air interface which the RLSP system 100 processes in an SDR is defined by the configuration bits presently active in the reconfigurable resources 204 of the RLSP system 100. When an air interface or other signal processing or other configuration is called into action, the configuration file (i.e. configuration bits) is loaded from the configuration storage memory 212 to the RLSP system 100's configuration registers. In this example, the configuration registers are shown within the reconfigurable resources 204 of the RLSP system 100. In some cases, more than one arrangement of the RLSP system 100's reconfigurable resources 204 may be used to implement signal processing for an air interface, essentially time-sharing the reconfigurable resources 204.

Rather than store a raw file of configuration bits to transfer later to the RLSP system 100's reconfigurable resources 204, the configuration data can be stored as a compressed version of the configuration data using, for example, Lempel-Ziv or Huffman compression coding (or any other suitable lossless compression scheme). Since several (time-shared) configurations of the RLSP's reconfigurable resources 204 may be used for each air interface, the cumulative memory savings for implementing many air interfaces is clear. The significance is even greater considering the air-time savings of transmitting compressed configuration files instead of raw files for updates.

A method used to decompress the configuration for the RLSP system 100's reconfigurable resources 204 in accordance with certain embodiments of the present invention uses a configuration or partial configuration of the RLSP system 100's reconfigurable resources 204 to carry out the decompression. Rather than implementing the decompression in a fixed-purpose application specific integrated circuit (ASIC) block, a traditional digital signal processor (DSP), microprocessor or other dedicated hardware, the configuration file is decompressed on the fly by a small section of the RLSP system 100's reconfigurable resources 204, thus eliminating the need for the additional hardware. Furthermore, the computational resources deployed in the RLSP system 100 to run the decompression algorithm can be deallocated upon completion, releasing them to do signal processing work. Because the RLSP system 100's function is flexible and defined in the configuration file itself, the choice of compression algorithm is flexible and can be changed to meet memory versus performance requirements.

At least two methods are contemplated for carrying out a decompression process in accordance with the current embodiment—a pipelined method and an non-pipelined method as described below:

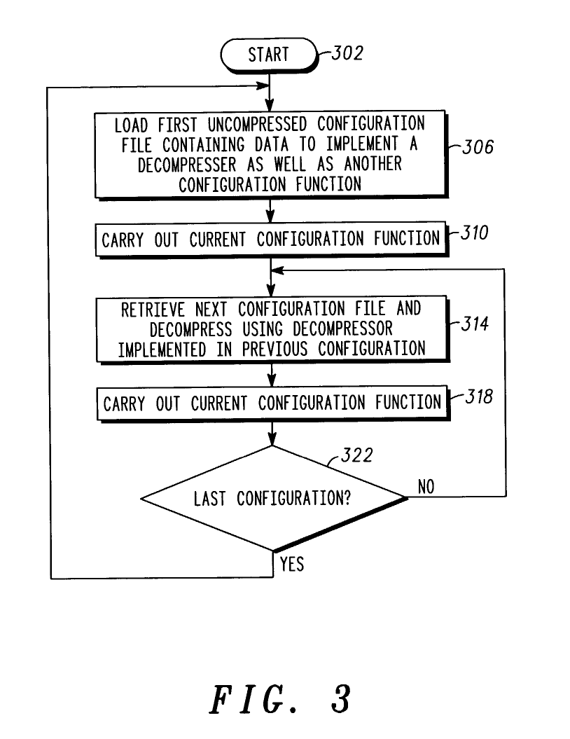

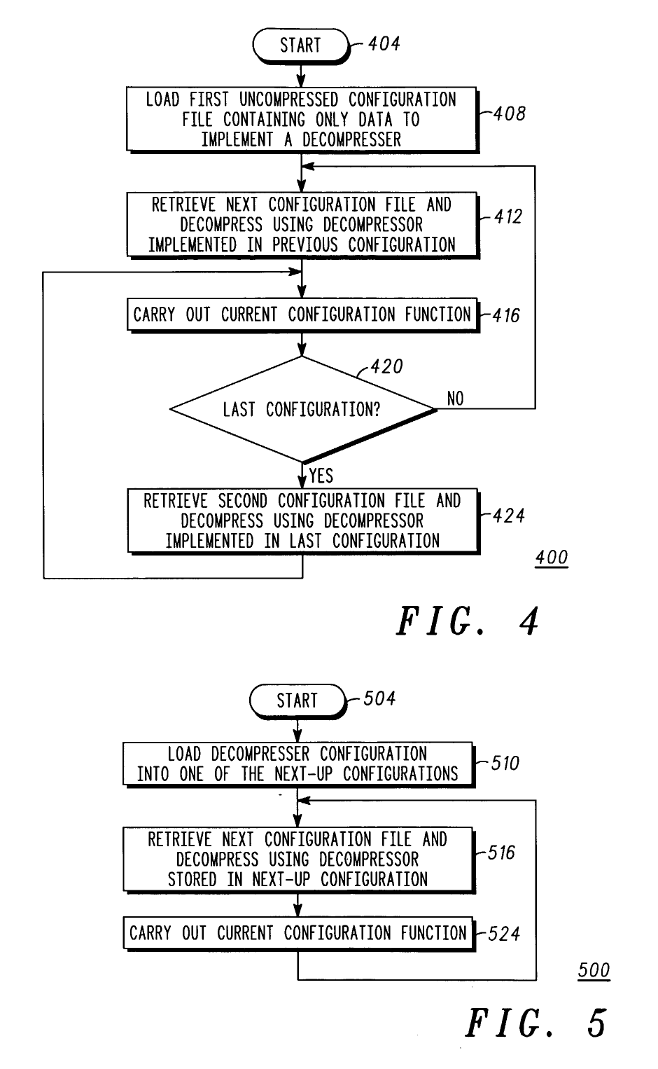

Still referring to FIG. 2, multiple configuration files are stored in the configuration storage memory 212. Each configuration file defines a different way of utilizing the RLSP's reconfigurable resources 204. According to the pipelined methods depicted in examples shown as process 300 of FIG. 3 and process 400 of FIG. 4, the configuration files configures the RLSP 100 to perform AI signal processing along with a decompression algorithm. These examples assume that a series of signal processing functions are carried out sequentially and then looped back to the beginning, for illustrative purposes. However, those skilled in the art will understand that these examples are merely intended to illustrate the nature of the pipeline process and that other process flows can equally well be implemented. The first configuration file loaded into the RLSP is either uncompressed or partially compressed. Two exemplary methods that can be used as described below to handle the first configuration in the pipeline which, of course, is different since it contains initial instructions to start the pipeline.

In the first method depicted in FIG. 3 starting at 302, the first active configuration file that is retrieved contains uncompressed configuration data, that configures at least a portion of the resources of reconfigurable resource 204 to do signal processing and decompression for the next-up configuration at 306. This way, signal processing can begin immediately. Thus, the signal processing function is carried out at 310. The next configuration is then loaded and decompressed using the previously loaded decompressor at 314. The current configuration's signal processing function is then carried out at 318 and this process of 314 and 318 repeats until the last configuration in a sequence is detected at 322. The process then returns to the first configuration at 306. The tradeoff for use of this process is a relatively small difference of memory in this uncompressed first configuration.

In a second method depicted as process 400 of FIG. 4, the first active configuration file contains only uncompressed decompression instructions so that decompression can occur as rapidly as possible. Since only decompression instructions are in this first uncompressed configuration, the file will not occupy much memory. This process starts at 404 after which the first configuration file is loaded at 408 to implement the decompresser. The next configuration file is retrieved at 412 and is decompressed to the next-up configuration registers using the previously loaded decompresser. This configuration is loaded after decompression and the function of the configuration is carried out at 416. Unless this is the last configuration in a sequence at 420, the process repeats with the next configuration being decompressed using a decompresser implemented in the current configuration. At 424, if the last configuration in a sequence is implemented, the second configuration file is retrieved and decompressed using the decompresser implemented in the last configuration and control returns to 416. The tradeoff in using this approach is that the signal processing in the next-up configuration is delayed. This is an acceptable tradeoff for many situations.

When the RLSP system 100 loads a new configuration file into the next-up configuration registers of the reconfigurable resources 204, a portion of the reconfigurable resources 204 of RLSP system 100 reads in the compressed configuration file through the memory access control 208 and begins decompressing it to the next-up configuration registers in the RLSP system 100's reconfigurable resources itself. The portion of the reconfigurable resources 204 in the active configuration which is allocated for signal processing continues to process AI signals independently. Note that the next-up configuration will contain instructions to decompress the configuration following itself, etc. This is the pipeline. A portion of the reconfigurable resources 204 in the RLSP system 100 is assigned to decompression only temporarily. Other methods will occur to those skilled in the art upon consideration of the above description including, but not limited to, combinations of these two methods.

Once decompression is complete, the reconfigurable resources are assigned to signal processing tasks, essentially tearing down the decompressor and reusing the reconfigurable resources that were initially deployed to do the decompression. For a given configuration, each ALU 220 can support multiple different instructions that are selected by control logic 216 for that ALU 220. The result of one ALU 220 can thus feed the control logic of another ALU 220 within the bank of ALUs and change its operation.) Effectively, the reassigning of resources after decompression makes the computational overhead for decompression very small, since a particular configuration of the RLSP system 100's reconfigurable resources 204 are likely to be instantiated for a long time relative to the duration of the decompression function.

Thus, certain embodiments of the present invention provide a new pipelined method for decompressing configuration files for an RLSP system 100, where the RLSP 100's reconfigurable resources 204 are used to decompress configuration files as they are loaded into the RLSP configuration registers. In certain implementations of the pipelined decompression method, the decompression algorithm is part of each of the compressed configuration files, so that the as each file is decompressed into the next-up configuration registers, the algorithm will be present to continue the pipelined process. In the pipelined decompression method described above, the portion of the RLSP system 100's reconfigurable resources 204 dedicated to the decompression algorithm can be time shared with another function by utilizing RLSP conditional instructions. This is accomplished by making all decompression instructions conditional on a flag indicating whether the decompression operation has finished. When decompression is complete, different instructions can be executed on those computation resources, such as signal processing. This minimizes the overhead of the decompression.

In one embodiment of the pipelined decompression method described above, the compression algorithm embedded in each compressed configuration file can be varied to implement different compression algorithms which can be optimized for the expected next configurations or optimized for the amount of resources that can be dedicated for compression in each configuration.

A non-pipelined method can also be implemented without departing from the present invention, such as that illustrated as process 500 of FIG. 5 starting at 504. If several next-up configurations are supported in the RLSP system 100's reconfigurable resources 204, then a non-pipelined approach can be used wherein a decompression algorithm can be loaded and maintained in one of the next-up configuration registers at 510 and used only when new next-up configurations are loaded. Thus, in an alternate method to the pipelined decompression method for an RLSP system 100 with multiple next-up configurations, the decompression algorithm is in a single uncompressed configuration file and is maintained in one next-up configuration and used in the RLSP system 100 to decompress any new configuration files. Whenever a new configuration file is retrieved at 516, it is decompressed using the decompresser stored in the next-up configuration in 510. The current configuration function is carried out at 524 and the process returns to repeat at 516. Other arrangements will occur to those skilled in the art after consideration of the present disclosure without departing from the present invention.

Thus, a reconfigurable logic signal processor 100 and method of configuring same in accordance with the present invention stores a plurality of configuration files 262, 264, . . . , 266 in a configuration storage memory 212 in compressed form. A portion of the reconfigurable resources 204 of the RLSP 100 is configured as a decompresser to provide for decompression of the compressed configuration files 262, 264, . . . , 266. The reconfigurable resources 204 of the RLSP 100 may be utilized to implement signal processing functions 114 as well as internal system level functions 120 such as the decompresser described above.

The invention as described has several benefits beyond the reduction in configuration memory needed to store a given number of configurations. An additional benefit is that the configuration of RLSP is decompressed on the RLSP itself, requiring no dedicated hardware for the decompression. Additionally, the decompression algorithm is part of the configuration bit pattern itself, so the next bits to define the next configuration's decompression algorithm are compressed. The decompression process can be pipelined to ensure minimal overhead. The decompression algorithm, in some instances, can be destroyed upon completion of the decompression process to free up computational resources for signal processing. Use of compressed configuration data results in a reduction in configuration size and download time for new configurations pulled/pushed down over the air interface.

The decompression algorithm is flexible in that it can be changed to trade off for memory/speed/result/size. It can be done on a configuration-by-configuration basis. For example, the first configuration can use Decompression Algorithm 1 and the second can use Decompression Algorithm 2 (or none at all) as dictated by system requirements.

Thus, as previously described, a reconfigurable logic signal processor (RLSP) system 100, consistent with certain embodiments of the present invention has a reconfigurable resource block 204 that is configured to operate in a circuit configuration defined by configuration data loaded therein. A configuration storage memory 212 stores configuration data for N configurations of the RLSP system 100, wherein at least one of the N configurations is stored as compressed configuration data. A decompression configuration is loaded from the configuration storage memory 212 to the reconfigurable resource block to implement a decompresser using a specified portion of the reconfigurable resource block 204. The decompresser decompresses the at least one of the N configurations stored as compressed configuration data for loading into reconfigurable resource block 204.

A method of configuring a reconfigurable logic signal processor (RLSP) system 100 consistent with certain embodiments of the present invention loads a decompression configuration into a reconfigurable resource block 204 of the RLSP system 100 to implement a data decompresser in a specified portion of the reconfigurable resource block; decompresses a segment of compressed configuration data using the data decompresser to produce a decompressed configuration; and loads the decompressed configuration into the reconfigurable resource block 204.

Those skilled in the art will appreciate that manufacturer's may choose to utilize maximum integration to produce a fully integrated RLSP system embracing all of the major components of RLSP system 100. However, manufacturers may also choose to fabricate individual parts of the architecture and utilize off-the-shelf memory, control processors etc. Any such combination of integrated and nonintegrated resources can be utilized to realize embodiments of the current invention without limitation. Moreover, while the present reconfigurable resources were shown to have ALU, Multiplier, Programmable logic, local data memory, resource interconnections and general purpose I/O blocks that can be reconfigured, other reconfigurable resources may have some or all of the above as well as other reconfigurable resources without departing from the invention.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A reconfigurable logic signal processor (RLSP) system, comprising:
a control processor executing a set of control instructions; and
a reconfigurable resource block that is configured to perform a programmed function when configuration data are loaded into a plurality of registers,
wherein the configuration data are loaded into the plurality of registers under control of said control processor, and
wherein a first plurality of said registers store configuration data to configure at least a first portion of the reconfigurable resource to carry out an operation that processes at least a portion of one of said configuration data and said control instructions.

2. The RLSP system according to claim 1, wherein a second plurality of said registers store configuration data to configure at least a second portion of the reconfigurable resource to carry out a signal processing function.

3. The RLSP system according to claim 2, wherein the first plurality of said registers contains a current configuration and the second plurality of said registers contains a next-up configuration.

4. The RLSP system according to claim 2, wherein the first and second plurality of registers define a portion of a single configuration of the reconfigurable resource block.

5. The RLSP system according to claim 1, wherein the first plurality of said registers store configuration data to configure at least a first portion of the reconfigurable resource to carry out a data decompression function that decompresses compressed configuration data.

6. The RLSP system according to claim 5, wherein the compressed configuration data is compressed using lossless compression.

7. The RLSP system according to claim 5, wherein the first plurality of said registers store configuration data to configure at least a first portion of the reconfigurable resource to carry out at least one of an error detection function and an error correction function.

8. The RLSP system according to claim 2, wherein the first plurality of registers is loaded with a data to reconfigure the first portion of the reconfigurable resource to perform another function after the operation that processes at least a portion of one of said configuration data and said control instructions is completed.

9. A method of configuring a reconfigurable logic signal processor (RLSP) system, comprising:
in a control processor, executing a sequence of control instructions that control the configuration of reconfigurable resources of the RLSP system;
executing control instructions that load a first portion and a second portion of a configuration into the reconfigurable resource block of the RLSP system,
wherein the first portion implements an operation that processes at least a portion of one of said configuration data and said control instructions in at least a first specified portion of the reconfigurable resource block and wherein the second portion implements a signal processing function in at least a second specified portion of the reconfigurable resource block;
carrying out the operation that processes at least a portion of one of said configuration data and said control instructions using the first specified portion of the reconfigurable resource block; and
carrying out the signal processing function using the second specified portion of the reconfigurable resource block.

10. The method of configuring an RLSP according to claim 9, wherein the operation that processes at least a portion of one of said configuration data and said control instructions comprises a data decompression function that decompresses compressed configuration data.

11. The method of configuring an RLSP according to claim 10, wherein the compressed configuration data is compressed using lossless compression.

12. The method of configuring an RLSP according to claim 10, wherein the operation that processes at least a portion of one of said configuration data and said control instructions comprises at least one of an error detection function and an error correction function.

13. The method of configuring an RLSP according to claim 9, wherein the first and second portions of the configuration comprise portions of a single configuration and wherein the signal processing function and the operation that processes at least a portion of one of said configuration data and said control instructions are carried out substantially simultaneously in a single configuration.

14. The method of configuring an RLSP according to claim 9, wherein the first specified portion of the reconfigurable resource block is reallocated to perform another function after the an operation that processes at least a portion of one of said configuration data and said control instructions is completed.

15. The method of configuring an RLSP according to claim 10, wherein the first and second plurality of registers define a portion of a single configuration of the reconfigurable resource block.

16. The method of configuring an RLSP according to claim 9, wherein the first portion defines a portion of a current configuration and wherein the second portion defines a portion of a next-up configuration.

17. A reconfigurable logic signal processor (RLSP) system, comprising:
a reconfigurable resource block that is configured to operate in a circuit configuration defined by configuration data loaded therein;
a configuration storage memory that stores configuration data for N configurations of the RLSP, wherein at least one of the N configurations is stored as compressed configuration data; and
means for loading a decompression configuration from the configuration storage memory to the reconfigurable resource block to implement a decompresser using a specified portion of the reconfigurable resource block,
wherein the decompresser decompresses the at least one of the N configurations stored as compressed configuration data for loading into reconfigurable resource block.

18. The RLSP system according to claim 17, wherein the specified portion of the reconfigurable resource block is reallocated to perform another function after the configuration is decompressed.

19. The RLSP system according to claim 17, wherein the compressed configuration data is compressed using lossless compression.

20. The RLSP system according to claim 17, wherein a sequence of configurations are loaded into the reconfigurable resource block, and wherein the decompression configuration comprises a first of the sequence of configurations.

21. A method of configuring a reconfigurable logic signal processor (RLSP) system, comprising:
loading a decompression configuration into a reconfigurable resource block of the RLSP system to implement a data decompresser in a specified portion of the reconfigurable resource block;
decompressing a segment of compressed configuration data using the data decompresser to produce a decompressed configuration; and
loading the decompressed configuration into the reconfigurable resource block.

22. The method of configuring an RLSP according to claim 21, further comprising reallocating the specified portion of the reconfigurable resource block after the decompressing.

23. The method of configuring an RLSP according to claim 21, wherein the compressed configuration data is compressed using lossless compression.

24. The method of configuring an RLSP according to claim 21, wherein a decompression configuration forms a part of a plurality of configurations, so that a current configuration contains a decompression configuration used to decompress a next configuration in a pipeline of configurations.

25. The method of configuring an RLSP according to claim 24, wherein a portion of the reconfigurable resources dedicated to the decompression algorithm is time shared with another function by utilizing RLSP conditional instructions.

26. The method of configuring an RLSP according to claim 25, wherein decompression functions carried out by the decompresser are conditional on a flag indicating whether the decompression operation has finished.

27. The method of configuring an RLSP according to claim 26, wherein when decompression functions are complete, a non-decompression instruction is executed using the reconfigurable resources allocated to decompression.

28. The method of configuring an RLSP according to claim 24, wherein the next configuration has a second decompresser, and wherein the first decompresser and the second decompresser use a different decompression algorithm.

29. The method of configuring an RLSP according to claim 21, wherein the RLSP utilizes multiple next-up configurations, and wherein the decompresser is implemented using a single uncompressed configuration file and is maintained in one next-up configuration and used in the RLSP to decompress any newly loaded configuration data.
